(19) United States
(12) Patent Application Publication
(10) Pub. No.: US 2009/0106023 A1
(43) Pub. Date: Apr. 23, 2009

(54) Speech recognition word dictionary/language model making system, method, and program, and speech recognition system

(76) Inventor: Kiyokazu Miki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/227,331

(22) PCT Filed: Nov. 30, 2007
(86) PCT No.: PCT/JP2007/060136

§ 371 Date: Nov. 14, 2008

(30) Foreign Application Priority Data
May 31, 2006 (JP) 2006-150961

(51) Int. Cl. G10L 15/06; G10L 15/18; G06F 17/27

(52) U.S. Cl. 704/245; 704/251; 704/257; 704/9; 704/E15.004; 704/E15.039; 704/E15.014

(57) ABSTRACT

A speech recognition word dictionary/language model making system for creating a word dictionary for recognizing a word not appearing in a learning text by selecting a word-generation-model-learning-method-by-word-class according to the word to be added which does not appear in the learning text and for making a language model. The speech recognition word dictionary/language model making system (100) includes a language model estimating device (111) for selecting estimating method information from a learning-method-knowledge-by-word-class storing section (109) for each word class of an addition word generating model which is a word generating model of the addition word according to the selected estimating method information and a database combining device (112) for adding an addition word to a word dictionary (105) and adding an addition word generating model to a word-generation-model-by-word-class database (107).

### TECHNICAL FIELD

The present invention relates to a speech recognition word dictionary/language model making system, a speech recognition word dictionary/language model making method, and a speech recognition word dictionary/language model making program. More specifically, the present invention relates to a speech recognition word dictionary/language model making system, a speech recognition word dictionary/language model making method, and a speech recognition word dictionary/language model making program capable of adding a word not appearing in a language model learning text to a word dictionary and a language model with accuracy in a speech recognition device using a statistical language model.

### BACKGROUND ART

Patent Document 1 depicts an example of a related language model learning method. As shown in FIG. 9, a related language model learning device 500 includes, as the parts that creates a language model, a word dictionary 512, a class-chain-model memory 513, an in-class-word-generation-model memory 514, a classifying text conversion device 521, a class-chain-model estimating device 522, a classifying application rule extracting device 523, a word-generation-model-by-class estimating device 524, a class-chain-model learning text data 530, an in-class-word-generation-model learning text data 531, a class definition description 532, and a learning-method-knowledge-by-class 533.

The language model learning device 500 having such constitution operates as follows. That is, with this related device, the language model is configured with a class chain model and an in-class-word-generation model, which are separately learned based on the language model learning text data. The class chain model shows how the classes in which words are abstracted are linked. The in-class-word-generation model shows how a word is generated from the class.

When acquiring the class chain model, the classifying text conversion device 521 refers to the class definition description 532 to convert the class-chain-model learning text data 530. The class-chain-model estimating device 522 estimates a class chain model using the class string and stores it in the class-chain-model memory 513.

Meanwhile, regarding the in-class-word-generation-model, the classifying rule extracting device 523 refers to the class definition description 532, and performs mapping of the classes and words for the in-class-word-generation-model learning text data 531. The word-generation-model-by-class estimating device 524 determines a learning method for each class by referring to the learning-method-knowledge-by-class 533, estimates the in-class-word-generation model by referring to the mapping of the classes and the words as necessary, and stores those in the in-class-word-generation-model memory 514.

A language model with high accuracy can be acquired by properly using the learning methods that are prepared in advance in the learning-method-knowledge-by-class 533 according to the classes.

Patent Document 1: Japanese Unexamined Patent Publication 2003-263187

### DISCLOSURE OF THE INVENTION

The first issue is that the related language model learning method cannot reflect a word not appearing in the learning text to the word dictionary and the language model appropriately.

The reason is that the related language model learning method does not have any device that can reflect a word not appearing in the learning text to the word dictionary and the language model appropriately.

The second issue is that the related language model learning method cannot necessarily use an optimal learning-method-by-class for each class.

The reason is that the learning-method-by-class needs to be determined in advance in the related language model learning method, and the learning method cannot be changed according to the data actually observed for each class.

An object of the present invention is to provide a speech recognition word dictionary/language model making system that is capable of creating a word dictionary and a language model which can recognize a word not appearing in the learning text by selecting a word-generation-model-learning-method-by-word-class according to a word to be added, when adding the word not appearing in the learning text for making the speech recognition word dictionary and the language model.

Another object of the present invention is to provide a speech recognition word dictionary/language model making system capable of making a language model by automatically selecting an appropriate word-generation-model-learning-method-by-word-class according to the distribution of the words belonging to each class in the learning text.

A first speech recognition word dictionary/language model making system of the present invention includes: a language model estimating device which selects estimating method information from a learning-method-knowledge-by-word-class storage section for each of the word classes of addition words that are words not appearing in a learning text, and creates, for each of the classes, an addition word generation model as a word generation model of the addition words according to the selected estimating method information; and a database combining device which adds the addition words to a word dictionary and adds the addition word generation models to a word-generation-model-by-word-class database.

With the above-described speech recognition word dictionary/language model making system, the language model estimating device selects the appropriate estimating method information from the learning-method-knowledge-by-word-class storage section for each of the word classes of the addition words, and creates the addition word generation models of the addition words based thereupon. The database combining device adds the addition words to the word dictionary and adds the addition word generation models to the word-generation-model-by-word-class database.

Therefore, it is possible to add the addition word not appearing in the learning text to the word dictionary and the language model with the proper learning method that corresponds to the class of the word.

A second speech recognition word dictionary/language model making system of the present invention includes: a language model estimating device which selects distribution-form information that matches best with distribution forms of each of the classes of words contained in a learning text from the distribution-form information contained in the learning-method-knowledge database, and creates, for each of the classes, an addition word generation model as a word generation model of the addition words that are words not appearing in a learning text according to the selected distribution-form information; and a database combining device which adds the addition words to the word dictionary and adds the addition word generation models to the word-generation-model-by-word-class database.

With the second speech recognition word dictionary/language model making system described above, the language model estimating device selects the distribution form for estimating the language models of the addition words based on the distribution of the words in the learning text.

Therefore, it is possible to create the language model by automatically selecting the appropriate distribution form in accordance with the distribution of the words belonging to each class in the learning text.

A speech recognition word dictionary/language model making method of the present invention creates a speech recognition word dictionary and a language model by: selecting estimating method information for each word class of addition words that are words not appearing in a learning text from a learning-method-knowledge-by-word-class storage section to which the estimating method information describing estimating methods of language generation models are stored in advance for each of the word classes; creating, for each of the classes, an addition word generation model as a word generation model of the addition word according to the selected estimating method information; and adding the addition words to the word dictionary while adding the addition word generation models to the word-generation-model-by-word-class database.

The above-described speech recognition word dictionary/language model making method: selects the appropriate estimating method information from the learning-method-knowledge-by-word-class storage section for each of the word classes of the addition words; creates the addition word generation models of the addition words based thereupon; and adds the addition words to the word dictionary while adding the addition word generation models to the word-generation-model-by-word-class database.

Therefore, it is possible to add the addition word not appearing in the learning text to the word dictionary and the language model with the proper learning method that corresponds to the class of the word.

A second speech recognition word dictionary/language model making method of the present invention creates a speech recognition word dictionary and a language model by: selecting distribution-form information that matches best with distribution forms of each class of words contained in a learning text from a learning-method knowledge database to which a plurality of pieces of the distribution-form information showing distribution forms of word generation probabilities are stored in advance; creating, for each of the classes, an addition word generation model as a word generation model of addition words that are words not appearing in a learning text according to the selected distribution-form information; and adding the addition words to the word dictionary while adding the addition word generation models to the word-generation-model-by-word-class database.

With the second speech recognition word dictionary/language model making system described above, the language model estimating device selects the distribution form for estimating the language models of the addition words based on the distribution of the words in the learning text.

Therefore, it is possible to create the language model by automatically selecting the appropriate distribution form in accordance with the distribution of the words belonging to each class in the learning text.

A speech recognition system of the present invention performs speech recognition by using the speech recognition word dictionary and the word-generation-model-by-word-class database created by the first or second speech recognition word dictionary/language model making method described above.

The speech recognition word dictionary and the word-generation-model-by-word-class database of the speech recognition system described above contain the addition words and the generation models learned by the appropriate learning method according to the classes.

Therefore, it is possible to improve the accuracy of speech recognition compared to the case of using the word dictionary and the language model which are generated only from the learning text.

A speech recognition word dictionary/language model making program of the present invention enables a computer to execute: processing for selecting estimating method information for each class of addition words that are words not appearing in a learning text from a learning-method-knowledge-by-word-class storage section to which the estimating method information describing estimating methods of language generation models are stored in advance for each of the word classes; processing for creating, for each of the classes, an addition word generation model as a word generation model of the addition words according to the selected estimating method information; and processing for adding the addition words to the word dictionary and adding the addition word generation models to the word-generation-model-by-word-class database.

The above-described speech recognition word dictionary/language model making program makes it possible to: select the appropriate estimating method information from the learning-method-knowledge-by-word-class storage section for each of the word classes of the addition words; create the addition word generation models of the addition words based thereupon; and add the addition words to the word dictionary while adding the addition word generation models to the word-generation-model-by-word-class database.

Therefore, it is possible to add the addition word not appearing in the learning text to the word dictionary and the language model with the proper learning method that corresponds to the class of the word.

A second speech recognition word dictionary/language model making program of the present invention enables a computer to execute: processing for selecting distribution-form information that matches best with distribution forms of each class of words contained in a learning text from a learning-method-knowledge database to which a plurality of pieces of the distribution-form information showing distribution forms of word generation probabilities are stored in advance; processing for creating, for each of the classes, an addition word generation model as a word generation model of the addition words that are words not appearing in a learning text according to the selected distribution-form information; and processing for adding the addition words to the word dictionary and adding the addition word generation models to the word-generation-model-by-word-class database.

With the second speech recognition word dictionary/language model making program described above, the language model estimating device selects the distribution form for estimating the language models of the addition words based on the distribution of the words in the learning text.

Therefore, it is possible to create the language model by automatically selecting the appropriate distribution form in accordance with the distribution of the words belonging to each class in the learning text.

The present invention is designed to: select the appropriate estimating method information from the learning-method-knowledge-by-word-class storage section for each of the word classes of the addition words; create the addition word generation models of the addition words based thereupon; and add the addition words to the word dictionary while adding the addition word generation models to the word-generation-model-by-word-class database.

Therefore, it is possible to add the addition word not appearing in the learning text to the word dictionary and the language model with the proper learning method that corresponds to the class of the word.

### BEST MODE FOR CARRYING OUT THE INVENTION

The constitution and the operation of a language model making system 100 as an exemplary embodiment of the invention will be described by referring to the accompanying drawings.

Referring to FIG. 1, the language model making system 100 (an example of a speech recognition word dictionary/language model making system) is configured with a personal computer, for example, and it includes a word-class chain model estimating device 102, a word-generation-model-by-word-class estimating device 103, a word-generation-model-by-addition-word-class estimating device 111 (an example of a language model estimating device), and a word-generation-model-by-addition-word-class database combining device 112 (an example of a database combining device).

The language model making system 100 includes a storage device such as a hard disk drive, and a learning text 101, a word class definition description 104, a word class chain model database 106, a word-generation-model-by-word-class database 107, a word dictionary 105, an addition word list 108, a learning-method-knowledge-by-word-class 109 (an example of learning-method-knowledge-by-word-class storage part), and an addition word class definition description 110 are stored in the storage device. A language model 113 is configured with the word class chain model database 106 and the word-generation-model-by-word-class database 107.

Each of those devices operates roughly as follows.

The learning text 101 is text data prepared in advance.

The addition word list 108 is a word list prepared in advance.

The word dictionary 105 is a list of words to be targets of speech recognition, which can be acquired from the learning text 101 and the addition word list 108.

The word class definition description 104 is data prepared in advance, which describes word classes to which the words appearing in a text belong. For example, a part of speech described in a dictionary (a general Japanese dictionary and the like) such as noun, proper noun, or interjection can be used as a word class, and a part of speech automatically given to the text by using a morphological-analysis tool can also be used as a word class. Further, a word class automatically acquired from the data using a statistical method such as automatic clustering executed based on criteria, which makes the entropy depending on the appearance probability of a word the minimum, can be used as well.

The addition word class definition description 110 is data prepared in advance, which describes a word class to which the word appearing in the addition word list 108 belongs. A word class based on a part of speech or a statistical method can be used as the word class, in the same way as in the word class definition description 104.

The word-class chain model estimating device 102 converts the learning text 101 into class strings according to the word class definition description 104 to estimate the chain probability of the word classes. An N-gram model, for example, can be used as a word class chain model. As an estimating method of the probability, likelihood estimation, for example, can be used. In this case, it can be estimated as in following Expression 1 (when N=2 in N-gram).

$$P ( {c}_{n} \vert {c}_{n - 1} ) = \frac{Count ( {c}_{n - 1} , {c}_{n} )}{Count ( {c}_{n - 1} )} \qquad ( Expression 1 )$$

Here, “c” indicates a word class and “Count” indicates the number of times the event in a parenthesis is observed.

The word class chain model database 106 stores a concrete database of the word class chain model acquired by the word-class chain model estimating device 102.

The word-generation-model-by-word-class estimating device 103 converts a learning text into word classes and words belonging to the word classes, and estimates a word-generation-model-by-word-class database with an estimating method that corresponds to each class in accordance with the learning-method-knowledge-by-word-class 109. For example, when performing likelihood estimation based on the learning text, following Expression 2 can be used.

$$P ( w \vert c ) = \frac{Count ( w )}{Count ( c )} \qquad ( Expression 2 )$$

The word-generation-model-by-addition-word-class estimating device 111 determines the word class in accordance with the addition word class definition description 110 for each word included in the addition word list 108, and estimates a word-generation-model-by-word-class database of the addition word (an example of the addition-word-generation model) depending on each class in accordance with the learning-method-knowledge-by-word-class 109. For example, when the distribution of the words included in the addition word list is a uniform distribution, following Expression 3 can be used as the estimating method.

$$P ( w \vert c ) = \frac{1}{ \begin{matrix}The number of types \\ of words belonging to {class}_{c}\end{matrix}} \qquad ( Expression 3 )$$

The word-generation-model-by-addition-word-class database combining device 112 combines the word-generation-model-by-word-class database of the words appearing in the learning text with the word-generation-model-by-word-class database of the addition words to generate a new word-generation-model-by-word-class database, and stores it in the word-generation-model-by-word-class database 107. As a way of combining the databases, the uniform distribution 1/N is given to the addition words, for example, and following expression 4 can be used to combine it with the words appearing in the learning text.

$${P}^{′} ( w \vert c ) = \frac{\frac{1}{N} + P ( w \vert c )}{{\sum }_{e ∈ c} \{ \frac{1}{N} + P ( {w}^{′} \vert c ) \}} \qquad ( Expression 4 )$$

Here, P (w/c) of the right-hand side is the probability acquired from the word-generation-model-by-word-class database of the words appearing in the learning text when an addition word “w” appears also in the learning text.

When prior distribution Cw is given to the addition word, following Expression 5, for example, can be used to combine the databases.

$${P}^{′} ( w / c ) = \frac{max \{ {C}_{w} , P ( w / c ) \}}{{\sum }_{w ∈ c} \{ max \{ {C}_{w} , P ( {w}^{′} / c ) \} \}} \qquad ( Expression 5 )$$

Each of the above-described devices can be realized when a CPU (Central Processing Unit) of the language model making system executes a computer program to control hardware of the language model making system 100.

The whole operation of the language model making system 100 will be described in detail by referring to the flowcharts of FIG. 2-FIG. 5.

First, a method for making the word dictionary 105 and the language model 113 based on the learning text 101 will be described by referring to FIG. 2-FIG. 4.

FIG. 2 is a flowchart showing a method for making the word class chain model database 106.

First, the word-class chain model estimating device 102 converts the learning text 105 into word strings (step A1 of FIG. 2). Next, the word strings are converted into class strings according to the word class definition description 104 (step A2). Furthermore, a word class chain model database is estimated for the words included in the learning dictionary by using likelihood estimation and the like based on the frequency of N-gram, for example, from the class strings (step A3).

FIG. 3 is a flowchart showing a method for creating the word dictionary 105.

First, the learning text 101 is converged into word strings (Step B1 of FIG. 3). Next, different words are extracted from the word strings (the same word is not extracted) (step B2 of FIG. 3). Furthermore, the word dictionary 105 is formed by listing the different words (step B3 of FIG. 3).

FIG. 4 is a flowchart showing a method for making a word-generation-model-by-word-class database for the words appearing in the learning text 101.

First, the word-generation-model-by-word-class estimating device 103 converts the learning text 101 into word strings (step C1 of FIG. 4). Next, the word strings are converted into class strings according to the word class definition description 110 (step C2 of FIG. 4). Furthermore, a word-generation-model-by-word-class estimating method is selected from the learning-method-knowledge-by-word-class 109 for each class appearing in the learning text 101 (step C3 of FIG. 4). Moreover, a word-generation-model-by-word-class database is estimated based on the selected word-generation-model-by-word-class estimating method for each word (step C4 of FIG. 4).

Next, a method for making the word dictionary 105 and the language model 113 based on an addition word list and a way of combining those with the language model based on the learning text 101 will be described by referring to FIG. 5 and FIG. 6.

FIG. 5 is a flowchart showing the method for making the word dictionary 105 including addition words.

The word-generation-model-by-addition-word-class estimating device 111 extracts, among the addition words included in the addition word list 106, words that are not included in the word dictionary 105 acquired from the learning text 101 (step D1 of FIG. 5). The extracted words are additionally registered to the word dictionary 105 (step D2 of FIG. 5).

FIG. 6 is a flowchart showing the method for making a language model for the addition words.

First, the word-generation-model-by-addition-word-class estimating device 111 converts the addition word list into a class list according to the addition word class definition description 110 (step E1 of FIG. 6). Next, the word-generation-model-by-word-class estimating method suitable for each class is selected from the learning-method-knowledge-by-word-class 109 (step E2 of FIG. 6). Furthermore, a word-generation-model-by-word-class database (addition-word-generation model) for the addition word based on the selected word-generation-model-by-word-class estimating method is estimated for each word (step E3 of FIG. 6).

For each word, the word-generation-model-by-addition-word-class database combining device 112 combines the word-generation-model-by-word-class database of the words appearing in the learning text with the word-generation-model-by-word-class of the addition word (step E4 of FIG. 6).

Described above is the case of having one addition word list 108. However, the same is true for a case where there are a plurality of addition word lists 108. However, when there are a plurality of word lists, there are considered a case of adding the list sequentially, a case of adding the lists collectively, and a case of employing a combination of those. The former case occurs, for example, when the words are added in order of time, e.g., one is old and the other is new. The latter case occurs, for example, when the words are added from a plurality of fields. The only difference between those cases is whether to include a part of addition words (sequential addition) or not to include a part of addition words (collective addition) as the existing word dictionary and the language model. Both cases can be dealt with the exemplary embodiment.

In the former case, the language model including the former addition words and the language model of the newly added word are to be combined. In this case, the words included in the former addition words among newly added word will be more emphasized to be added compare to other addition words, which has an emphasizing effect by adding the same word repeatedly. However, reflection of the distribution itself for each class may be weakened.

In the latter case, all the addition words including the former addition words are to be added to the language model learned only from the learning text. In this case, the characteristic of the class can be reflected directly upon the addition word by deleting the addition history, contrary to the sequential addition. However, the history of the added words is to be lost.

Next, the effect of the language model making system 100 will be described.

The exemplary embodiment of the present invention is structured to: have the addition word list 108; select an appropriate word-generation-model-by-word-class estimating method for each class, and estimate a word-generation-model-by-word-class database; combine it with the word-generation-model-by-word-class for the words appearing in the learning text 101, and add the addition word list 108 to the word dictionary 105. Therefore, it is possible to create the appropriate language model 113 for the words not appearing in the learning text 101, and to create the word dictionary 105 including the addition word.

Next, a language model making system 200 as a second exemplary embodiment of the invention will be described in detail by referring to the accompanying drawing. Since the language model making system 200 has many common components with the language model making system 100 of FIG. 1, the same reference numerals as those of FIG. 1 are given to the common components, and explanations thereof are omitted.

Reference to FIG. 7, compared with the language model making system 100 of FIG. 1, the learning-method-knowledge-by-word-class 109 is omitted and a word-generation-distribution-by-word-class calculating device 201, a learning-method-knowledge-by-word-class selecting device 202 and a learning-method-knowledge database 203 are added.

Each of those devices roughly operates as follows.

The word-generation-distribution-by-word-class calculating device 201 calculates, according to a predetermined method, a word-generation distribution by word class from the classes and the words belonging thereto, which are converted from the learning text. For example, the word-generation distribution by word class is calculated by the likelihood estimation based on the frequency in the text.

A predetermined distribution is stored in the learning-method-knowledge database 203. As the distribution forms, there are a uniform distribution, an exponential distribution, and a predetermined prior distribution, for example.

The learning-method-knowledge-by-word-class selecting device 202 compares the word-generation distribution by word class for each class acquired from the learning text with the predetermined distribution stored in the learning-method-knowledge database 203 to select appropriate distribution form for each class. When a distribution close to the uniform distribution such as proper noun is acquired from the learning text, for example, the uniform distribution is automatically selected to the proper noun class.

Unlike the case of the first exemplary embodiment, the word-generation-model-by-word-class estimating device 103 and the word-generation-model-by-addition-word-class estimating device 111 use the distribution form that the learning-method-knowledge-by-word-class selection device 202 has determined as a word-generation-model-by-word-class estimating method.

Next, the effect of the language model making system 200 will be described.

The language model making system 200 is structured such that a word-generation-model-by-word-class estimating method for each class is selected among predetermined distribution forms stored in the learning-method-knowledge database 203 based on the word-generation distribution by word class for each class calculated from the learning text 101, and the addition word list 108 is added to the word dictionary. Therefore, an appropriate word-generation-model-by-word-class estimating method according to the appearance in the learning text 101 can be selected. Thus, it is possible to create the language model 113 in which the method is applied to the addition words, and to create the word dictionary 105 including the addition words.

Next, a speech recognition system 300 as a third exemplary embodiment of the invention will be described.

FIG. 8 is a functional block diagram of the speech recognition system 300.

The speech recognition system 300 includes: an input section 301 that is configured with a microphone, for example, to input speeches of a user; a speech recognition section 302 that recognizes the speech inputted from the input section 301 and converts it into a recognition result such as a character string; and an output section 303 that is configured with a display unit, for example, for outputting the recognition result.

The speech recognition section 302 performs speech recognition by referring to the language model 113, which is configured with the word class chain model database 106 and the word-generation-model-by-word-class database 107, and to the word dictionary 105.

The language model 113 and the word dictionary 105 are created by the language model making system 100 of FIG. 1 or the language model making system 200 of FIG. 7.

Next, other exemplary embodiments of the present invention will be described one by one.

The estimating method of the speech recognition word dictionary/language model making system mentioned above may include an estimating method in which the distribution of word-generation probabilities is a uniform distribution.

This makes it possible to create a generation model with high accuracy by applying the estimating method of the uniform distribution for the word classes that are known to have a uniform distribution, such as names of places or names of persons.

The estimating method of the speech recognition word dictionary/language model making system mentioned above may include an estimating method in which the distribution of word-generation probabilities is a predetermined prior distribution.

In the speech recognition word dictionary/language model making system mentioned above, the distribution-form information may include the uniform distribution.

This makes it possible to create a generation model with high accuracy by applying the estimating method of the uniform distribution for the word classes that are known to have a uniform distribution, such as names of places or names of persons.

In the speech recognition word dictionary/language model making system mentioned above, the distribution-form information may include the predetermined prior distribution.

In the speech recognition word dictionary/language model making system mentioned above, a part of speech can be used as a word class.

With this, words are classified based on contents information such as names of places or names of persons, or grammar information such as verb or adjective. Each of these is expected to have a peculiar distribution. Moreover, it is possible to make classifications at a low cost by using existing resources such as a general Japanese dictionary and the like.

In the speech recognition word dictionary/language model making system mentioned above, a part of speech acquired by the morphological analysis of words may be used as a word class.

In the speech recognition word dictionary/language model making system mentioned above, a class acquired by automatic clustering of words may be used as a word class.

This makes it possible to well-reflect the characteristics of the words that are in the appearance situation in an actual text compared with the case using a part of speech.

The estimating method of the speech recognition word dictionary/language model making method mentioned above may include an estimating method in which the distribution of word-generation probabilities is the uniform distribution.

This makes it possible to create a generation model with high accuracy by applying the estimating method of the uniform distribution for the word classes that are known to have a uniform distribution such as names of places or names of persons.

The estimating method of the speech recognition word dictionary/language model making method mentioned above may include an estimating method in which the distribution of word-generation probabilities is the predetermined prior distribution.

In the speech recognition word dictionary/language model making method mentioned above, the distribution-form information may include the uniform distribution.

This makes it possible to create a generation model with high accuracy by applying the estimating method of the uniform distribution for the word classes that are known to have a uniform distribution such as names of places or names of persons.

In the speech recognition word dictionary/language model making method mentioned above, the distribution-form information may include the predetermined prior distribution.

In the speech recognition word dictionary/language model making method mentioned above, a part of speech can be used as a word class.

With this, words are classified based on contents information such as names of places or names of persons, or grammar information such as verb or adjective. Each of these is expected to have a peculiar distribution. Moreover, it is possible to make classifications at a low cost by using existing resources such as a general Japanese dictionary and the like.

In the speech recognition word dictionary/language model making method mentioned above, a part of speech acquired by the morphological analysis of words can be used as a word class.

In the speech recognition word dictionary/language model making method mentioned above, a class acquired by automatic clustering of words may be used as a word class.

This makes it possible to well-reflect the characteristics of the words that are in the appearance situation in an actual text compared with the case of using a part of speech.

The estimating method of the speech recognition word dictionary/language model making program mentioned above may include an estimating method in which the distribution of word-generation probabilities is the uniform distribution.

This makes it possible to create a generation model with high accuracy by applying the estimating method of the uniform distribution for the word classes that are known to have a uniform distribution such as names of places or names of persons.

The estimating method of the speech recognition word dictionary/language model making program mentioned above may include an estimating method in which the distribution of word-generation probabilities is the predetermined prior distribution.

In the speech recognition word dictionary/language model making program mentioned above, the distribution-form information may include the uniform distribution.

This makes it possible to create a generation model with high accuracy by applying the estimating method of the uniform distribution for the word classes that are known to have a uniform distribution such as names of places or names of persons.

In the speech recognition word dictionary/language model making program mentioned above, the distribution-form information may include the predetermined prior distribution.

In the speech recognition word dictionary/language model making program mentioned above, a part of speech can be used as a word class.

With this, words are classified based on contents information such as names of places or names of persons, or grammar information such as verb or adjective. Each of these is expected to have a peculiar distribution. Moreover, it is possible to make classifications at a low cost by using existing resources such as a general Japanese dictionary and the like.

In the speech recognition word dictionary/language model making program mentioned above, a part of speech acquired by the morphological analysis of words may be used as a word class.

In the speech recognition word dictionary/language model making program mentioned above, a class acquired by automatic clustering of words may be used as a word class.

This makes it possible to well-reflect the characteristics of the words that are in the appearance situation in an actual text compared with the case of using a part of speech.

While the present invention has been described in accordance with the exemplary embodiments, the present invention is not limited to the aforementioned embodiments. Various changes and modifications are possible within a spirit and scope of the contents of the appended claims.

This application is based upon and claims the benefit of priority from Japanese patent application No. 2006-150961, filed on May 31, 2006, the disclosure of which is incorporated herein in its entirety by reference.

### BRIEF DESCRIPTION OF THE DRAWINGS

FIG. 1 is a block diagram showing a language model making system as a first exemplary embodiment of the invention;

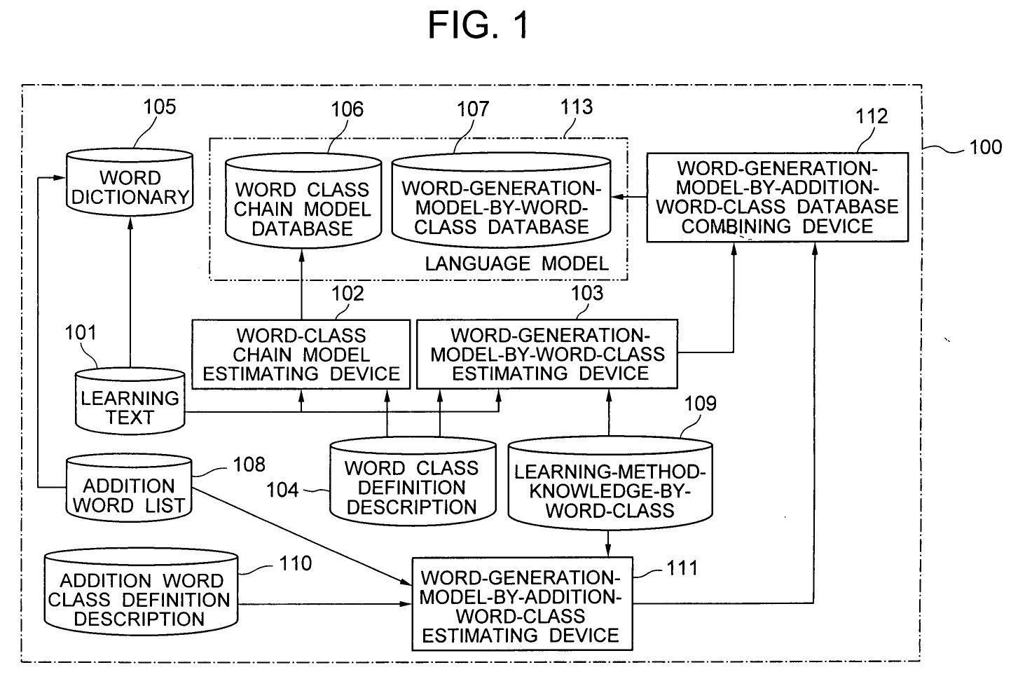

FIG. 2 is a flowchart showing an operation for making a word class chain model database of the language model making system;

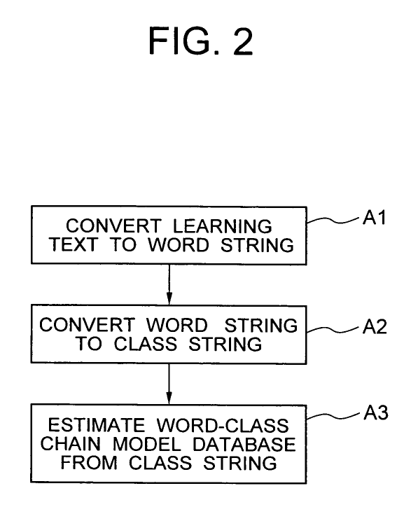

FIG. 3 is a flowchart showing an operation for making a word dictionary of the language model making system;

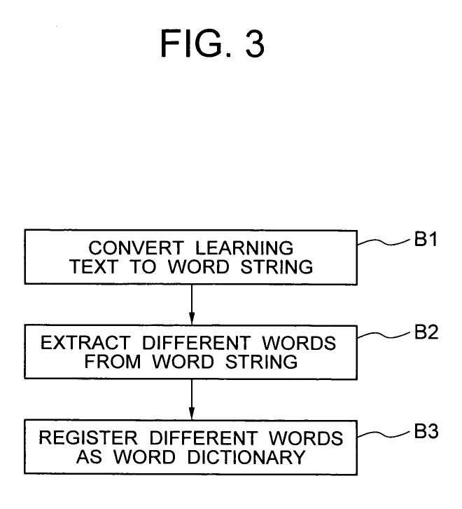

FIG. 4 is a flowchart showing an operation for making a word-generation-model-by-word-class database of the language model making system;

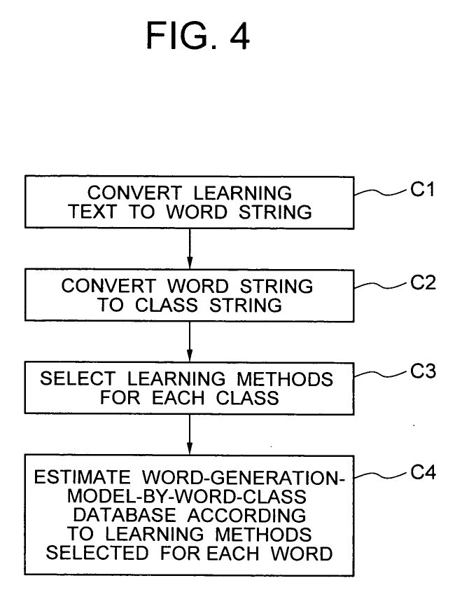

FIG. 5 is a flowchart showing an operation for making a word dictionary including addition words of the language model making system;

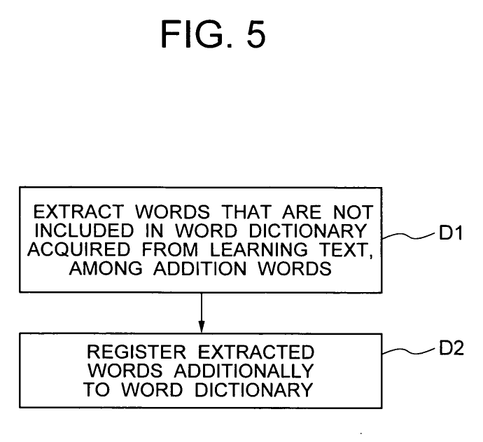

FIG. 6 is a flowchart showing an operation for making a language model of the language model making system regarding the addition words;

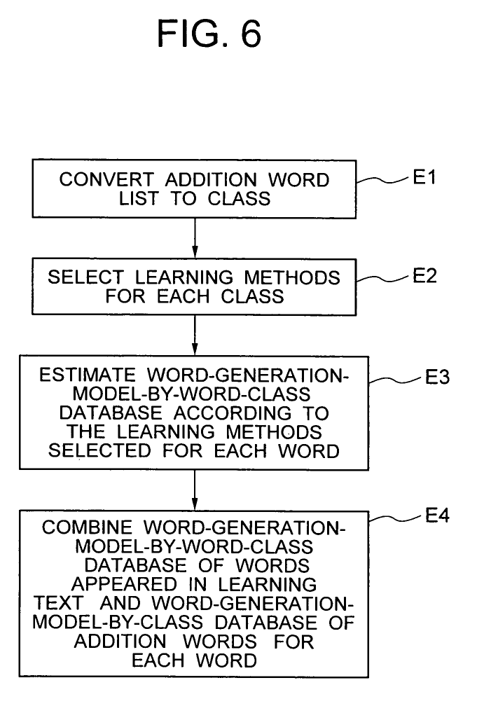

FIG. 7 is a block diagram showing a language model making system as a second exemplary of the present invention;

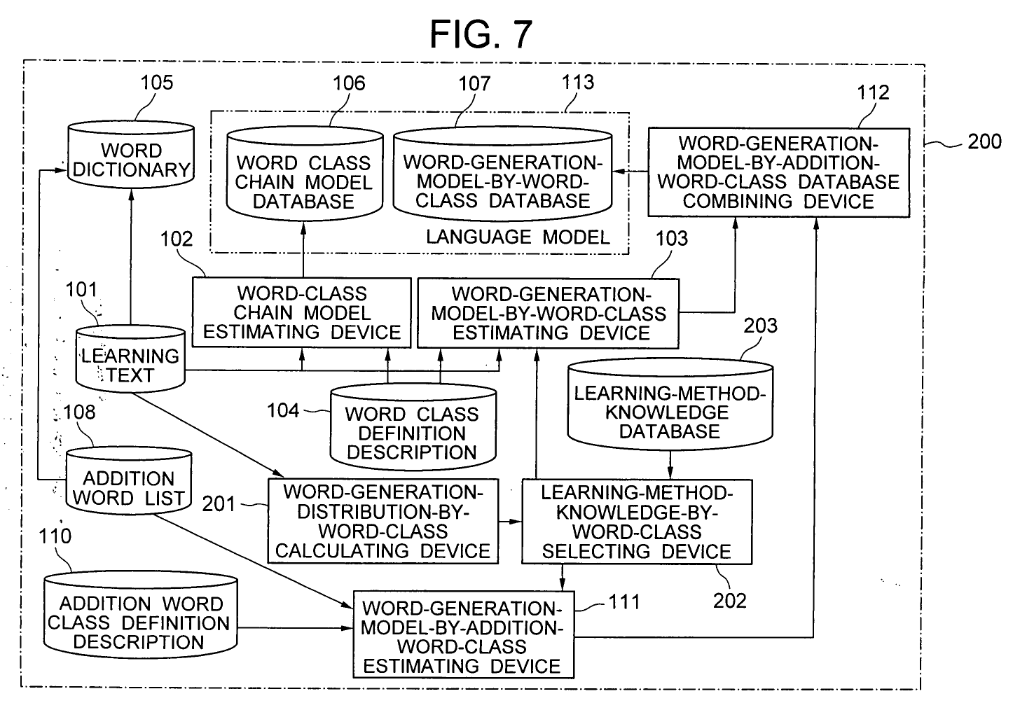

FIG. 8 is a block diagram showing a speech recognition system as a third exemplary embodiment of the invention; and

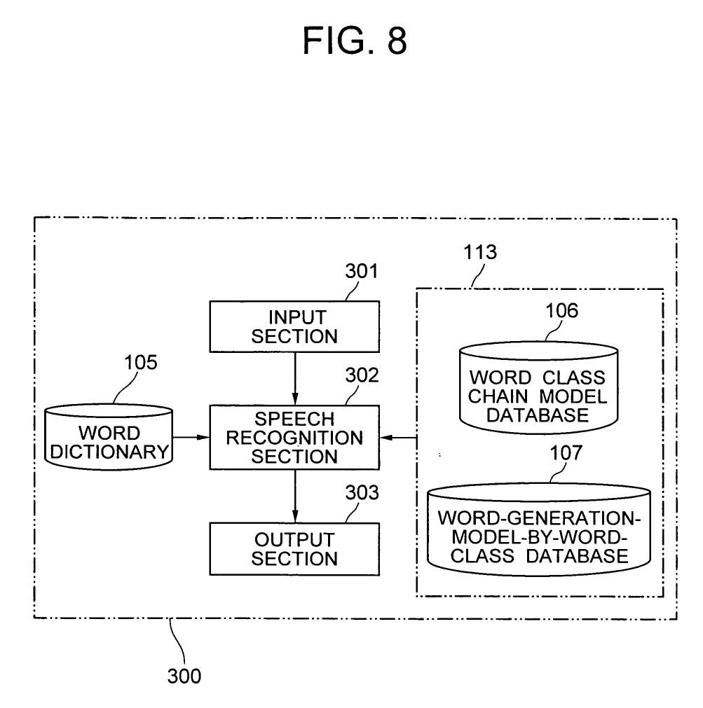

FIG. 9 is an illustration for describing a related language model making method.

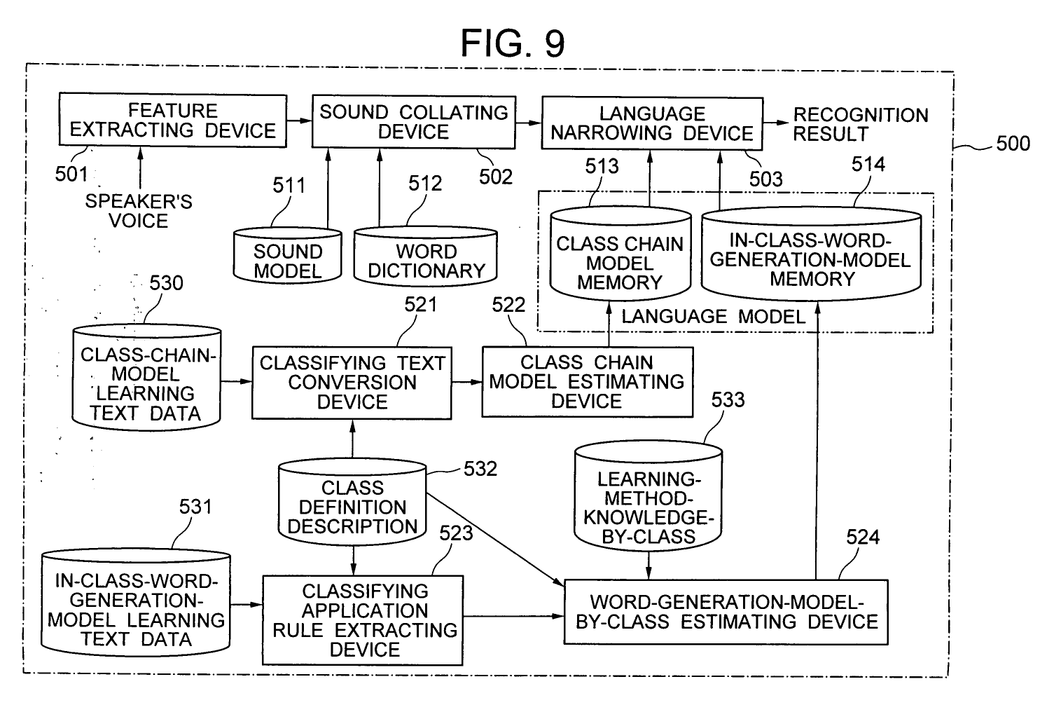

### REFERENCE NUMERALS

100 Language model making system
101 Learning text
102 Word-class chain model estimating device
103 Word-generation-model-by-word-class estimating device
104 Word class definition description
105 Word dictionary
106 Word class chain model database
107 Word-generation-model-by-word-class database
108 Addition word list
109 Learning-method-knowledge-by-word-class
110 Addition word class definition description
111 Word-generation-model-by-addition-word-class estimating device
112 Word-generation-model-by-addition-word-class database combining device
200 Language model making system
201 Word-generation-distribution-by-word-class calculating device
202 Learning-method-knowledge-by-word-class selecting device
203 Learning-method-knowledge database
300 Speech recognition system

1.-28. (canceled)

29. A speech recognition word dictionary/language model making system, comprising a speech recognition word dictionary, a word-generation-model-by-word-class database, and a learning-method-knowledge database to which a plurality of pieces of distribution-form information showing distribution forms of word generation probabilities are stored in advance, wherein the system comprises:
a language model estimating device which selects the distribution-form information that matches best with the distribution forms of each of the classes of words contained in a learning text from the distribution-form information contained in the learning-method-knowledge database, and creates, for each of the classes, an addition word generation model as a word generation model of the addition words that comprise words not appearing in a learning text according to the selected distribution-form information; and
a database combining device which adds the addition words to the word dictionary and adds the addition word generation models to the word-generation-model-by-word-class database.

30. The speech recognition word dictionary/language model making system as claimed in claim 29, wherein the distribution-form information includes uniform distribution.

31. The speech recognition word dictionary/language model making system as claimed in claim 29, wherein the distribution-form information includes prescribed prior distribution.

32. The speech recognition word dictionary/language model making system as claimed in claim 29, wherein a part of speech is used as the word class.

33. The speech recognition word dictionary/language model making system as claimed in claim 29, wherein a part of speech acquired by conducting a morphological analysis of the words is used as the word class.

34. The speech recognition word dictionary/language model making system as claimed in claim 29, wherein a class acquired by conducting automatic clustering of the words is used as the word class.

35. A speech recognition word dictionary/language model making system, comprising a speech recognition word dictionary, a word-generation-model-by-word-class database, and a learning-method-knowledge database to which a plurality of pieces of distribution-form information showing distribution forms of word generation probabilities are stored in advance, wherein the system comprises:
language model estimating means for selecting the distribution-form information that matches best with the distribution forms of each of the classes of words contained in a learning text from the distribution-form information contained in the learning-method-knowledge database, and creating, for each of the classes, an addition word generation model as a word generation model of the addition words that comprise words not appearing in a learning text according to the selected distribution-form information; and
database combining means for adding the addition words to the word dictionary and adding the addition word generation models to the word-generation-model-by-word-class database.

36. A speech recognition word dictionary/language model making method, which comprises:
selecting distribution-form information that matches best with distribution forms of each class of words contained in a learning text from a learning-method knowledge database to which a plurality of pieces of the distribution-form information showing distribution forms of word generation probabilities are stored in advance;
creating, for each of the classes, an addition word generation model as a word generation model of addition words that comprise words not appearing in a learning text according to the selected distribution-form information; and
adding the addition words to the word dictionary and adding the addition word generation models to the word-generation-model-by-word-class database.

37. The speech recognition word dictionary/language model making method as claimed in claim 36, wherein the distribution-form information includes uniform distribution.

38. The speech recognition word dictionary/language model making method as claimed in claim 36, wherein the distribution-form information includes prescribed prior distribution.

39. The speech recognition word dictionary/language model making method as claimed in claim 36, wherein a part of speech is used as the word class.

40. The speech recognition word dictionary/language model making method as claimed in claim 36, wherein a part of speech acquired by conducting a morphological analysis of the words is used as the word class.

41. The speech recognition word dictionary/language model making method as claimed in claim 36, wherein a class acquired by conducting automatic clustering of the words is used as the word class.

42. A speech recognition system which uses the speech recognition word dictionary and the word-generation-model-by-word-class database created by the method claimed in claim 36.

43. A computer readable recording medium storing a speech recognition word dictionary/language model making program for enabling a computer to execute:
processing for selecting distribution-form information that matches best with distribution forms of each class of words contained in a learning text from a learning-method-knowledge database to which a plurality of pieces of the distribution-form information showing distribution forms of word generation probabilities are stored in advance;
processing for creating, for each of the classes, an addition word generation model as a word generation model of the addition words that comprise words not appearing in a learning text according to the selected distribution-form information; and
processing for adding the addition words to the word dictionary and adding the addition word generation models to the word-generation-model-by-word-class database.

44. A computer readable recording medium storing the speech recognition word dictionary/language model making program as claimed in claim 43, wherein the distribution-form information includes uniform distribution.

45. A computer readable recording medium storing the speech recognition word dictionary/language model making program as claimed in claim 43, wherein the distribution-form information includes prescribed prior distribution.

46. A computer readable recording medium storing the speech recognition word dictionary/language model making program as claimed in claim 43, wherein a part of speech is used as the word class.

47. A computer readable recording medium storing the speech recognition word dictionary/language model making program as claimed in claim 43, wherein a part of speech acquired by conducting a morphological analysis of the words is used as the word class.

48. A computer readable recording medium storing the speech recognition word dictionary/language model making program as claimed in claim 43, wherein a class acquired by conducting automatic clustering of the words is used as the word class.
